(19) United States
(12) Patent Application Publication
(10) Pub. No.: US 2012/0295793 A1
(43) Pub. Date: Nov. 22, 2012

(54) METHODS OF GENERATING MODIFIED POLYNUCLEOTIDE LIBRARIES AND METHODS OF USING THE SAME FOR DIRECTED PROTEIN EVOLUTION

(75) Inventors: Christophe Ullman, Nimes (FR); Laurent Fourage, Calvisson (FR)

(73) Assignee: Proteus, Nimes (FR)

(21) Appl. No.: 13/574,514

(22) PCT Filed: Jan. 21, 2011
(86) PCT No.: PCT/IB2011/050288

§ 371 Date: Jul. 20, 2012

Related U.S. Application Data
(60) Provisional application No. 61/297,557, filed on Jan. 22, 2010.

(51) Int. Cl. C40B 10/00; C40B 50/06

(52) U.S. Cl. 506/1; 506/26

(57) ABSTRACT

The invention provides for methods of generating modified polynucleotide libraries by inserting and/or deleting at least three nucleotide residues in polynucleotide sequences. Theses methods may be used with other methods of gene modification such as gene shuffling. The invention further provides methods of directed molecular evolution using the modified polynucleotide libraries produced by these methods.

### BACKGROUND OF THE INVENTION

(a) Field of the Invention

The invention relates to methods of generating modified polynucleotide libraries. In particular, the invention relates to methods of producing modified polynucleotide libraries by inserting and/or deleting at least three nucleotide residues (e.g., one or more codons) in polynucleotide sequences. The invention also relates to methods of introducing variation into polynucleotide libraries by inserting and/or deleting nucleotide triplets in combination with other methods of gene modification such as, for example, gene shuffling. The invention further relates to methods of directed molecular evolution using the modified polynucleotide libraries produced by these methods.

According to the present text the term “library” must be understood as equivalent to group or pool. For example “a polynucleotide sequence library” or “modified polynucleotide fragment library” refers to a group or pool of different modified polynucleotides or fragments obtained from at least one parental polynucleotide, respectively. “Parental polynucleotide” refers to the polynucleotide(s) that is/are used to create modified polynucleotide fragments or a polynucleotide sequence library. Parental polynucleotides are often derived from genes.

(b) Description of the Related Art

The availability of directed protein evolution techniques and applications has increased significantly in the past few years. In particular, a number of techniques have been developed for introducing modifications or mutations into polynucleotides in order to increase the variations in a given population of polynucleotides. These techniques include directed and random mutagenesis, DNA shuffling and Error-Prone Polymerase Chain Reaction (epPCR). While techniques for creating genetic diversity by recombination or point mutations are well developed and widely applied, methods for incorporating insertion and deletion mutations randomly are still limited. The natural evolution of proteins, however, often involves the phenomenon of insertion and/or deletion mutation. Accordingly, the production of these types of mutations in vitro is important to the development of improved means of in vitro directed protein evolution.

Mutagenesis techniques involving insertion and/or deletion mutations are known in the art. However, many of these techniques suffer the disadvantages of being highly complex processes involving numerous steps and/or having a high probability of introducing undesired point mutations or open reading frame (ORF) frameshifts.

One method for introducing insertion or deletion mutations into polynucleotides is known as Random Insertion and Deletion mutagenesis, or RID mutagenesis (Hiroshi Murakami, et. al., Nature Biotechnology 20:76-81, 2002). RID mutagenesis enables deletion of an arbitrary number of consecutive bases at random positions and the simultaneous insertion of a specific sequence or random sequence of an arbitrary number of bases into the same position. However, RID mutagenesis comprises eight major steps, including multiple DNA cyclizations to product circular DNA constructs, cleavage and ligation steps, and PCR amplification. Accordingly, the RID method is extremely complicated. Moreover, this method leads to additional point mutations due to errors caused by error-prone polymerases during PCR amplifications.

Another method for implementing insertion or deletion mutations is know as Random Insertional-deletional Strand Exchange mutagenesis, or RAISE (Ryota Fujii, et al., Nucleic Acids Research, Vol. 34, No. 4, e30, 2006). The RAISE method is based on DNA shuffling and involves three principle steps: 1) fragmentation of DNA randomly by DNase I, 2) attachment of several random nucleotides to the 3′ fragments using terminal deoxynucleotidyl transferase, and 3) reconstruction of each fragment with a tail of random nucleotides into a complete sequence by self-priming PCR. Because the RAISE method depends upon PCR, error-prone DNA polymerase inevitably leads to the introduction of additional mutations. Moreover, because the insertion and deletion fragments are of random sizes, approximately two-thirds of the region-exchanged mutations included frameshifts.

Other methods for insertional mutagenesis rely upon transposons. For example, Hallet et al. have described a transposon-based method known as pentapeptide scanning mutagenesis that inserts polynucleotide sequences encoding a five amino acid cassette into a gene (Bernard Hallet, et al., Nucleic Acids Research, Vol. 25, No. 9, 1866-67, 1997). The random insertion of transposon Tn4430 followed by the deletion of the bulk of the transposon permits the insertion of a 15 by sequence into the target gene. Pentapeptide scanning mutagenesis is not capable of introducing deletion mutations and is limited to insertion mutations that give rise to the insertion of a pentapeptide within the protein encoded by the gene of interest.

Another transposon-based method for mutagenesis relies upon a modified mini-Mu transposon to achieve triplet deletion mutations (D. Dafydd Jones, Nucleic Acids Research, Vol. 33, No. 9 e80, 2005). This nucleotide triplet deletion mutagenesis method consists of several complicated steps, including transposon design and insertion, cell culture and selection, and PCR. Plasmids containing the transposon are isolated and pooled, and the transposon is removed by Mlyl digestion. Intramolecular ligation then results in the reformation of the mutated gene, minus 3 basepairs. This method is complicated and has the disadvantage of only permitting deletion events. Other mutagenesis methods using transposons are known in the art. See e.g., U.S. Pat. App. Pub. Nos. 2005/0074892 and 2009/0004702.

The mutagenesis techniques of the prior art that depend upon PCR lead to the introduction of additional and frameshift mutations due to the properties of DNA polymerase. Because DNA polymerases are not able to copy with absolute fidelity, polymerases introduce base substitution errors into the polynucleotide product with an error rate of between 10⁻² errors/base and 10⁻⁷ errors/base, depending upon the type of polymerase and whether or not the polymerase has proof-reading capabilities. Therefore, PCR-based methods lead to the production of polynucleotide library bearing additional point mutations introduced by the DNA polymerase. The introduction of additional mutations into the recombined sequences is generally deleterious to the functionality of the encoded protein; as a result, the quality of the library produced is greatly decreased.

The mutagenesis methods that employ pools of oligonucleotides require the design and chemical synthesis of these oligonucleotide sequences. These prior art methods are costly and complicated to use for the generation of random insertion and deletion mutations. Thus, the prior art methods are disadvantageous because they cannot easily and cost-effectively generate both insertions and deletions. Furthermore, PCR-based methods result in the introduction of additional point mutations, leading to poor quality of the obtained polynucleotide library.

Accordingly, there is a need in the art for a simple, reliable, and cost-effective method of generating polynucleotide libraries with deletion and/or insertion mutations. There is also a need in the field of directed protein evolution for a simple, reliable, and cost-effective method of creating polynucleotide libraries having advantageous characteristics (e.g. encoding improved proteins) as compared to one or more reference sequences.

### SUMMARY OF THE INVENTION

The present invention addresses these needs. For example, the invention overcomes the disadvantages of the prior art by providing a simple method of gene evolution by generating both insertions and deletions of at least one nucleotide triplets in a random or a directed way. In one of its embodiment, the invention also provides mutant polynucleotides library without introducing frameshift mutations in which at least one polynucleotide encoding a functional and/or improved protein can be identified and selected after a screening step. The invention also does not use PCR methods for introducing or deleting triplets. Therefore, the invention allows for the production of functional mutant libraries without the disadvantage of accidental point mutations introduced by imperfect nucleotide incorporation by DNA polymerase during PCR.

In one aspect, the invention provides for a method of making polynucleotide libraries comprising inserting and/or deleting at least one nucleotide triplet into polynucleotides. The invention also provides for polynucleotide libraries made by this and other processes.

In another aspect, the invention provides an in vitro method of directed protein evolution using libraries made by inserting and/or deleting at least one nucleotide triplet into polynucleotides.

In yet another aspect, the invention provides for a method of obtaining polynucleotide fragments for use in polynucleotide shuffling which includes the step of obtaining a library of mutant polynucleotides or polynucleotide fragments from a parental polynucleotide by inserting and/or deleting at least one nucleotide triplet into polynucleotides.

In yet another aspect, the invention provides for a method of producing a polynucleotide library by introducing restriction enzyme recognition sites into a specific region of a polynucleotide, and then inserting and/or deleting at least one nucleotide triplet into the specific region.

According to the present invention, the term “polynucleotide” or “polynucleotide sequence” refer to a nucleic acid sequence. A polynucleotide may be for example a gene, an operon or a genome. A polynucleotide can encode a protein. A polynucleotide can eventually be obtained by ligation of polynucleotide fragments.

, the term “fragment” or “polynucleotide fragment”. refer to the fragmented portions of polynucleotides as described above. Most or all of the fragments have undefined length and should be shorter than the polynucleotides.

### BRIEF DESCRIPTION OF THE DRAWINGS

FIG. 1 illustrates the deletion of a nucleotide triplet after digestion using BbvCl restriction enzyme. FIG. 1(a) shows the overhanging end generated, FIG. 1(b) shows the result of Mung Bean nuclease treatment, and FIG. 1(c) shows the new sequence deleted with the initial triplet.

FIG. 2 illustrates the insertion of a nucleotide triplet after digestion by the BbvCl restriction enzyme. FIG. 2(a) shows the overhanging end generated, FIG. 2(b) shows the result of T4 DNA polymerase treatment, and FIG. 2(c) shows the new sequence with the additional nucleotide triplet.

FIG. 3 depicts the representation of the lipase 3105 amplicon, with the localization of the Hinfl restriction site.

FIG. 4 depicts the agarose gel analysis of the lipase 3105 amplicon.

FIG. 5 is the Hinfl restriction site.

FIG. 6 shows the lipase 3105 after digestion by Hinfl restriction enzyme.

FIG. 7 depicts the agarose gel analysis of 5′ overhanging end Hinfl digestion followed by digestion with Mung Bean nuclease or filling with T4 DNA polymerase.

FIG. 8 depicts the agarose gel analysis of the ligation products, after digestion or filling of the 5′ overhanging ends, performed with Ampligase or T4 DNA ligase.

FIG. 9 is the agarose gel analysis of Hinfl digestion of isolated clones, showing that most of them are no longer digested by the restriction enzyme.

FIGS. 10(a) and 10(b) show sequence alignment of a portion of nucleic acid sequence of lip3105 in which one triplet insertion (a) or deletion (b) occurred. FIGS. 10(c) and 10(d) show sequence alignment of a portion of amino acid sequence of lip3105 in which one triplet insertion (c) or deletion (d) occurred.

FIG. 11 depicts activity results of isolated inserted or deleted clones, monitored by titration of p-nitrophenol liberated from 2-hydroxy-4-p-nitrophenoxy-butyl decanoate.

FIG. 12 is the illustration of the B9#1 Phytase amplicon, with the localization of the Eco0109I and RsrII restriction sites.

FIG. 13 is the agarose gel analysis of the B9#1 Phytase digested by Eco0109I or RsrII.

FIG. 14 is the agarose gel analysis of Eco0109I and RsrII digestion after T4 DNA polymerase filling.

FIG. 15 is the agarose gel analysis of isolated clones digested by Eco0109I and RsrII restriction enzymes, showing that these restriction sites are no longer present.

FIGS. 16(a) and 16(b) show sequence alignment of a portion of nucleic acid sequence of B9#1 in which one triplet insertion (a: using Eco0109I restriction site; b: using RsrII restriction site) occurred. FIGS. 16(c) and 16(d) show sequence alignment of a portion of amino acid sequence of B9#1 in which one triplet insertion (a: using Eco0109I restriction site; b: using RsrII restriction site) occurred.

FIG. 17 shows activity results of two clones wherein an amino acid was inserted.

### DETAILED DESCRIPTION OF THE INVENTION

The invention relates to various methods of generating polynucleotide libraries, in vitro directed protein evolution, and in vitro recombination involving the introduction of insertion and/or deletion mutations into polynucleotides that preserve the open reading frame of a gene encoded by the polynucleotide and avoid unintentional point mutations caused by PCR. For example, the invention provides methods for inserting and/or removing at least one nucleotide triplet from parental polynucleotides such that one or more codons within a gene encoded by the obtained modified polynucleotide are altered (i.e., removed, added, or otherwise modified).

### Methods for Producing Polynucleotide Libraries

The invention provides for the production of polynucleotide libraries. In one embodiment, the invention provides for a method of producing a polynucleotide library by applying one or more types of restriction enzymes to a parental polynucleotide to produce polynucleotide fragments, modifying the resulting polynucleotide fragments by inserting and/or deleting at least one nucleotide triplet to obtain modified polynucleotide fragments , and then constructing said polynucleotide library by linking at least two or more of the modified polynucleotide fragments together.

According to the invention, the restriction enzymes employed in the methods described herein cleave DNA asymmetrically so that the resulting polynucleotide fragments possess 3′ or 5′ single-stranded overhanging ends.

An “overhanging end” is a single-stranded portion of a polynucleotide that is otherwise substantially double-stranded that is produced when an asymmetrically-cutting restriction enzyme cleaves a double-stranded polynucleotide. Significantly, the asymmetrically-cutting restriction enzymes for use in the methods described herein are selected such that the overhanging ends of the polynucleotide fragments produced by their activity are made up of nucleotide residues in multiples of three. Typically, the resulting overhanging ends will consist of three nucleotide residues. However, the production of overhanging ends of three, six, nine, twelve, or more nucleotide residues is contemplated by the present invention. For example, a restriction enzyme such as TspRI, which produces 3′ overhanging ends that are nine nucleotide residues in length, is suitable for use in the methods described herein.

After one or more polynucleotide fragments have been generated by the application of the restriction enzyme(s), some or all of the resulting overhanging ends of the polynucleotide fragments are modified. The modification of an overhanging end may be accomplished by removing all of the nucleotide residues making up the overhanging end.

According to all of this the invention first relates to an in vitro method of obtaining a modified polynucleotide fragments library from parental polynucleotides, comprising:
(1) providing one or more parental polynucleotides
(2) applying one or more types of restriction enzymes to said parental polynucleotides to produce polynucleotide fragments, wherein at least one of said polynucleotide fragment comprises at least one overhanging end, said overhanging end comprising a single-stranded portion of said polynucleotide fragment, wherein said single-stranded portion comprises three nucleotide residues or nucleotide residues in multiple of three;
(3) modifying said at least one overhanging end of said polynucleotide fragment to produce a modified polynucleotide fragment, wherein said modifying comprises:
   (i) removing all of the nucleotide residues of said overhanging end of one or more polynucleotide fragments; or
   (ii) extending the single strand of the polynucleotide fragment complementary to the strand that comprises the overhanging end to make a double-stranded; or
   (iii) both (i) and (ii),
(4) recovering the resulting modified polynucleotide fragments as modified polynucleotide fragments library.

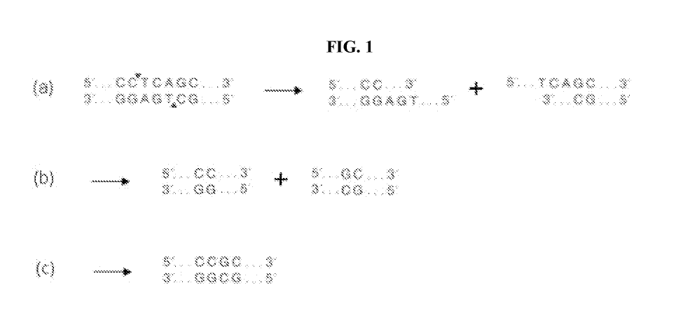

For example, FIG. 1(b) depicts Mung Bean Nuclease, an exonuclease, removing the three-nucleotide overhanging ends from the polynucleotide fragments generated when the BbvCl restriction enzyme is used to cleave a polynucleotide possessing the appropriate recognition site. The action of the exonuclease results in the removal of the single-stranded nucleotide residues of the overhanging ends, but does not affect double-stranded DNA. The application of exonuclease therefore results in blunt-ended modified polynucleotide fragments without overhanging ends.

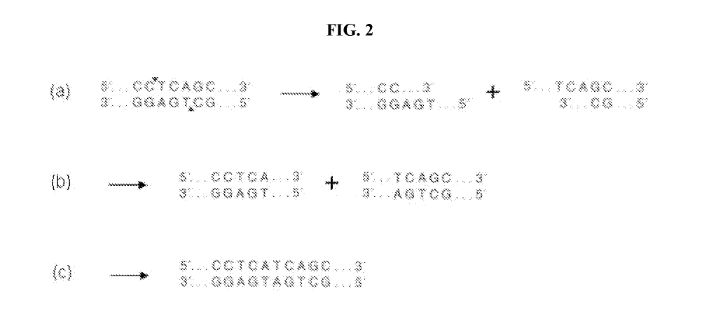

Alternatively, an overhanging end of a given polynucleotide fragment may be modified by filling in the single-stranded overhanging end to make it double stranded. For example, this “gap filling” modification is illustrated for a sequence cleaved by BbvCl in FIGS. 2(a) and (b). After restriction enzyme cleavage, two polynucleotide fragments, each with a 5′ overhanging end (i.e., TCA and AGT), are produced. The overhanging ends of these polynucleotide fragments can be modified by adding in the appropriate nucleotide residues complementary to the nucleotide residues of the overhanging ends. For example, a polymerase such as DNA Polymerase I could be used to extend the strand of the polynucleotide fragment that is complementary to the strand comprising the overhanging end, using the overhanging end as the template for DNA synthesis. This gap-filling modification results in blunt-ended double-stranded modified polynucleotide fragments. The gap-filling modification has the effect of increasing, rather than decreasing, the cumulative size of the two modified polynucleotide fragments as compared to the parental polynucleotide from which the two modified polynucleotide fragments were derived.

According to the invention a polynucleotide library can be then obtained using at least two or more of the modified polynucleotide fragments obtained in step 4 of the preceding described method.

According to this embodiment, the invention also relates to an in vitro method of obtaining modified polynucleotide library from parental polynucleotides, comprising:
(1) obtaining modified polynucleotide fragments according to the method of claim 1;
(2) linking at least two of said modified polynucleotide fragments together;
(3) recovering the resulting modified polynucleotide obtained in step 2) as modified polunucleotide library

One skill in the art understands that any known techniques can be used to link one or more modified polynucleotide(s) to each other or to other polynucleotides to produce the new polynucleotide libraries of the invention.

For example, as shown in FIG. 2(c), the modified polynucleotides produced by “gap filling” may be linked together, for example by a DNA ligase, to form a new polynucleotide. The resulting new polynucleotide will possess three extra nucleotide residues compared to the parental polynucleotide of the example. Similarly, the modified polynucleotides of FIG. 1(c), produced by exonuclease-mediated removal of single-stranded overhanging ends, may also be linked together to produce a new polynucleotide. The resulting new polynucleotide in this case will possess three fewer nucleotide residues compared to the parental polynucleotide of the example. One of skill in the art will understand that the new polynucleotide libraries produced by the methods illustrated in FIGS. 1 and 2 will be free of frameshift mutations. In another embodiment assembly template and a ligase could be used to create the new polynucleotide. “Assembly template” or “assembly matrix” refers to a polynucleotide used as a scaffold upon which fragments may anneal or hybridize to form a partially or fully double-stranded polynucleotide. The template may derive from the reference sequence. The template is directly or indirectly obtained for use as a template by a human being, or a computer operated thereby, via purposeful planning, conception, formulation, creation, derivation and/or selection of either a specific desired polynucleotide sequence(s) or a sequence(s) from a source(s) that is likely to contain a desired sequence(s). The template may be synthetic (ie oligonucleotide sequence), result from different DNA synthesis in vivo or in vitro processes, or it may exist in nature.

In a particular embodiment of constructing a new polynucleotide by linking a modified polynucleotide fragment to another polynucleotide or modified polynucleotide fragment, a modified DNA ligase can be used. Modified DNA ligase can be produced by molecular engineering to improve its ability to join DNA strands together to form a region of double-stranded DNA even in a presence of mismatch or nick.

Alternatively, various PCR-based techniques may also be used to link one or more modified polynucleotide fragment(s).

Restriction Enzymes

The restriction enzymes used in the invention include any 5′ (“five prime”) overhang and 3′ (“three prime”) overhang restriction enzymes, provided that the produced single-stranded sequence comprises at least three or a multiple of three nucleotides. These restriction enzymes include isoschizomers.

The 5′ overhang and 3′ overhang restriction enzymes recognize and cleave DNA asymmetrically at specific sites to produce overhanging ends. The 5′ overhang restriction enzymes cut asymmetrically within the recognition site such that a single-stranded segment of three or a multiple of three nucleotides extends from the 5′ ends. The 3′ overhang restriction enzymes cut asymmetrically within the recognition site such that a single-stranded segment of three or a multiple of three nucleotides extends from the 3′ ends. The 5′ or 3′ overhangs generated by enzymes that cut asymmetrically are also called sticky ends or cohesive ends, because they will readily stick or anneal with their partner by base pairing. This is in contrast to fragments generated by blunt end cutting restriction.

Restriction enzymes suitable for use in the methods described herein include, but are not limited to, AlwNI, ApeKI, AvaII, BbvCI, BgII, Blpl, Bpu10I, BsaXI, BsII, BspQI, BstAPI, Bsu36I, Ddel, DraIII, Earl, EcoO109I, Hinfl, Mwol, PflMI, PpuMI, RsrII, Sapl, Sau96I, Sfil, Tfil, Tsel, TspRI, Bpu1102I (Espl), BseLI (BsiYI), Cfr13I (Asul), Eco81I (Saul), Pasl, and Taul. Any other restriction enzyme known by those skilled in the art, provided that the produced single-stranded segment comprises at least three or a multiple of three nucleotides can be used in the methods described herein (e.g., thermostable restriction enzymes). These enzymes can be used alone or in combination with one another.

The invention also contemplates introducing the use of star (non specific recognition of the site) activity of some of restriction enzymes. Under non-standard reaction conditions, some restriction enzymes are capable of cleaving sequences which are similar, but not identical to their defined recognition sequence. This altered specificity has been termed “star activity.” It has been suggested that star activity is a general property of restriction endonucleases. The invention also contemplates the use of specific reaction conditions such as high glycerol concentration (>5% v/v), non-optimal buffer, presence of organic solvents such as DMSO, and substitution of Mg2+ with other divalent cations such as Mn2+, in order to change the site recognition. The invention further contemplates the use of specific reaction conditions such as by using different amount of enzymes or different incubation times, in order to allow partial digestion.

Exonucleases

Any enzyme having exonuclease activity known by those of skill in the art may be used in the methods described herein (e.g., thermostable exonucleases). Specific examples of exonucleases suitable for use in the methods described herein include, but are not limited to Exonuclease I (E. coli), Exonuclease T, Lambda Exonuclease, and Mung Bean Nuclease. These enzymes can be used alone or in combination with one another. Any other enzyme having exonuclease activity known by one skilled in the art can be used (for instance, thermostable exonuclease).

DNA Polymerases

Any enzyme having polymerase activity known by those of skill in the art may be used in the methods described herein (e.g., thermostable polymerases). Specific examples of DNA polymerases suitable for use in the methods described herein include, but are not limited to Bsu DNA Polymerase, Large Fragment; T7 DNA Polymerase (unmodified); DNA Polymerase I (E. coli); DNA Polymerase I, Large (Klenow) Fragment; Klenow Fragment (3′→5′ exo-); and T4 DNA Polymerase. These enzymes can be used alone or in combination with one another.

### Methods of In Vitro Directed Protein Evolution

Methods of in vitro directed protein evolution are provided herein. These methods can permit the production of new polynucleotide sequences encoding proteins having advantageous properties as compared with the proteins encoded by reference polynucleotide sequences.

Methods of directed protein evolution generally require the application of molecular biology techniques to introduce changes into the polynucleotide sequences. By introducing changes into the polynucleotide sequences, it is possible to construct populations, or libraries, of related polynucleotide sequences that each encodes different variations of a protein of interest. The fitness or desirability of these proteins can then be tested by measuring a characteristic of interest, such as the binding affinity or catalytic activity of the protein. Those proteins with the greatest binding affinity, catalytic activity, or other advantageous characteristic are deemed to be the “fittest” of their population of proteins.

The polynucleotide sequences encoding the fittest proteins are selected for inclusion in a subsequent population or library. Additional mutagenesis or other techniques are typically applied to the members of this subsequent population to generate increased variation in the subsequent population. The proteins encoded by the polypeptide sequences in the subsequent are again tested for fitness. This general process of creating variation in a population, testing the members of the population, and preferentially passing the fittest members of the population into a subsequent population can be repeated an unlimited number of times. This process, generically referred to as directed protein evolution, serves to mimic the effects of natural selection on populations of organisms. Accordingly, directed protein evolution can be employed to generate proteins with improved characteristics (e.g. binding affinity, catalytic activity, luminescence, etc.) as compared to their parental proteins.

The invention provides for methods of in vitro directed protein evolution. In one embodiment, the method comprises providing parental polynucleotides having a property of interest, digesting said parental polynucleotides with restriction enzymes to form fragments with single-stranded overhangs consisting of three nucleotide residues or of nucleotide residues in multiples of three, modifying the obtained fragments by removing and/or filling in the single-stranded overhangs to obtain modified fragments, constructing new polynucleotides comprising one or more of said modified fragments, and screening said new polynucleotides for improvements in the property of interest.

In another embodiment, the method further comprises repeating each of these steps one or more times, using the new polynucleotide(s) of one round of the method as the parental polynucleotide(s) in the next round of the method.

Thus the invention also relates to an in vitro method for directed protein evolution comprising:
(1) obtaining modified polynucleotide library according to the preceding described method;
(2) screening some or all of said modified polynucleotides to determine which polynucleotide or polynucleotides encode a protein or proteins of interest;

recovering the modified polynucleotide(s) encoding a protein or proteins of interest obtained in step (2) as modified polynucleotide(s) encoding a protein or proteins of interest

In another embodiment, the method comprises providing polynucleotides having a property of interest, digesting the polynucleotides with restriction enzymes to form fragments with single-stranded overhangs consisting of nucleotide residues in multiples of three, modifying the fragments by removing and/or filling in the single-stranded overhangs, constructing new polynucleotides comprising one or more of the modified fragments, and screening the new polynucleotides for improvements in the property of interest.

In another embodiment, the method further comprises repeating each of these steps one or more times, using the new polynucleotide(s) of one round of the method as the parental polynucleotide(s) in the next round of the method.

In a preferred embodiment, the method comprises:
(1) providing one or more parental polynucleotides encoding a protein with a given property;
(2) applying one or more types of restriction enzymes to the polynucleotide to produce polynucleotide fragments, wherein at least one polynucleotide fragment comprises at least one overhanging end, said overhanging end comprising a single-stranded portion of the polynucleotide fragment, wherein said single-stranded portion comprises nucleotide residues only in multiples of three;
(3) modifying said at least one overhanging end of a polynucleotide fragment to produce a modified polynucleotide fragment, wherein said modifying comprises:
   (i) removing, in multiples of three, all of the nucleotide residues of said overhanging end of one or more polynucleotide fragments; or
   (ii) extending the strand of the polynucleotide fragment complementary to the strand that comprises the overhanging end to make the single-stranded overhanging end of one or more polynucleotide fragments double-stranded; or
   (iii) both (i) and (ii);
(4) constructing a new polynucleotide library comprising the modified polynucleotide fragment;
(5) optionally screening some or all of the polynucleotides in the new polynucleotide library to determine which polynucleotide or polynucleotides encode a protein or proteins with an improved property or properties relative to the protein encoded by a reference polynucleotide; and
(6) and optionally repeating steps (1) to (5), wherein at least one of the polynucleotides of the new polynucleotide library is included as a parental polynucleotide.

It is understood that this process may be repeated an unlimited number of times. In each subsequent iteration of the process, some or all said modified polynucleotide fragment of the new polynucleotide libraries from the previous iteration are used as parental polynucleotide(s).

The nucleotide residues of the overhanging ends may be removed, for example, by digestion with an exonuclease as described herein. The nucleotide residues of the overhanging ends may also be modified, for example, by using a polymerase to extend the strand of the polynucleotide fragment complementary to the strand that comprises the overhanging end to make the single-stranded overhanging end of one or more polynucleotide fragments double-stranded. The new polynucleotide library may be constructed by linking a modified polynucleotide fragment to another polynucleotide or modified polynucleotide fragment, for example, by using a ligase or the Polymerase Chain Reaction

The invention contemplates methods of evolving a variety of proteins. In a particular embodiment, the invention provides for the in vitro production of restriction enzymes possessing novel recognition sites and/or cutting patterns.

In another embodiment, the invention contemplates introducing restriction enzyme recognition sites into particular regions of a gene (e.g., using silent mutagenesis), for example the region of a gene encoding the active site of an enzyme, so that insertion or deletion mutations can be concentrated in this region.

In another embodiment, the invention provides for methods of in vitro recombination and in vitro directed protein evolution in which the methods described herein are used in combination with other techniques for introducing variation into a library of polynucleotides. For example, the methods described herein may be combined with methods for introducing point mutations, various methods of gene shuffling, PCR-based mutagenesis techniques, or any other known method for introducing mutations or variation into polynucleotide sequences.

A variety of in vitro recombination methods have been described in the art. These methods generally involve making fragments and recombining the fragments. For example, U.S. Pat. Nos. 5,605,793 and 5,965,408, which are hereby incorporated by reference in their entirety, involve recombining fragments using polymerase chain reaction-like thermocycling of fragments in the presence of DNA polymerase. U.S. Pat. Nos. 6,951,719 and 6,991,922, which are hereby incorporated by reference in their entirety, describe thermocycling ligation to recombine fragments of more specific and increased gene size. These methods rely on a multistep process involving a fragmentation step to generate fragments of parental genes that are further assembled to create recombined polynucleotides. Fragmentation is obtained by random treatments (e.g., DNAse I, sonication, mechanical disruption), or by controlled treatments (e.g., restriction endonucleases). These fragmentation processes do not take into account the level of homology of the parental genes.

In particular embodiments, the invention provides methods for in vitro recombination and in vitro directed evolution in which the methods described herein are used in combination with methods of gene shuffling. Methods of gene shuffling are known in the art. See, e.g., U.S. Pat. Nos. 6,951,719 and 6,991,922, which are hereby incorporated by reference in their entirety. Generally, methods of gene shuffling comprise providing polynucleotide fragments (e.g., using random or controlled treatments described herein) derived from each of at least two heterologous polynucleotide sequences of a polynucleotide library; hybridizing the fragments to an assembly matrix so that the hybridized fragments are oriented for ligation with each other; and ligating the hybridized fragments with a ligase to form random recombinant polynucleotide sequences. Accordingly, some embodiments, the invention provides for methods of preparing polynucleotide libraries using the methods described herein and then performing gene shuffling on these polynucleotide libraries.

The invention also provides for methods of preparing polynucleotides for gene shuffling. In one embodiment, the invention provides for a method of obtaining polynucleotide fragments for use in polynucleotide shuffling, comprising:
(a) obtaining a library of polynucleotide fragments from at least one parental polynucleotide comprising
   (1) providing one or more parental polynucleotides encoding a protein with a selected property;
   (2) applying one or more types of restriction enzymes to the polynucleotide to produce polynucleotide fragments, wherein at least one polynucleotide fragment comprises at least one overhanging end, said overhanging end comprising a single-stranded portion of the polynucleotide fragment, wherein said single-stranded portion comprises nucleotide residues in multiples of three;
   (3) modifying said at least one overhanging end of a polynucleotide fragment to produce a modified polynucleotide fragment, wherein said modifying comprises:
      (i) removing, in multiples of three, all of the nucleotide residues of said overhanging end of one or more polynucleotide fragments; or
      (ii) extending the strand of the polynucleotide fragment complementary to the strand that comprises the overhanging end to make the single-stranded overhanging end of one or more polynucleotide fragments doublestranded; or
      (iii) both (i) and (ii),
      wherein said steps (1)-(3) are carried out in vitro; and
   (4) recovering the resulting modified polynucleotide fragments;
(b) constructing a library of mutant polynucleotides comprising the modified polynucleotide fragments using gene shuffling technology.

Methods of gene shuffling are known in the art and described herein. See, e.g., U.S. Pat. Nos. 6,951,719 and 6,991,922, which are hereby incorporated by reference in their entirety. In one embodiment, the gene shuffling technology is L-shuffling. See, e.g., U.S. Pat. No. 6,951,719, incorporated by reference herein in its entirety.

In a preferred embodiment, the invention provides for a method of in vitro recombination comprising:
(1) obtaining modified polynucleotide fragments according any one of the method described in any one of claims 1 to 5;
(2) screening some or all of said modified polynucleotides to determine which polynucleotide or polynucleotides encode a protein or proteins of interest;
(3) digesting said modified polynucleotides encoding a protein or proteins of interest with restriction enzymes to form fragments with single-stranded overhangs consisting of three nucleotide residues or of nucleotide residues in multiples of three;
(4) modifying the obtained polynucleotide fragments of step (3) by removing and/or filling in the single-stranded overhangs to obtain new modified fragments by
   (i) removing, in multiples of three, all of the nucleotide residues of said overhanging end of one or more polynucleotide fragments; or
   (ii) extending the single strand of the polynucleotide fragment complementary to the strand that comprises the overhanging end to make a double-stranded; or
   (iii) both (i) and (ii);
(1) hybridizing said modified polynucleotide fragments obtained in step 4 to an assembly matrix so that the hybridized fragments are oriented for ligation with each other;
(2) ligating said hybridized fragments with a ligase to form random recombinant polynucleotide fragments;
(3) recovering the resulting random recombinant polynucleotide fragments obtained in step (6).
   One of skill in the art will understand that this process can be repeated an arbitrary number of times to produce further libraries containing recombinant polynucleotide sequences. It will also be appreciated that steps (2)-(4) may be performed as described herein. Moreover, one of skill in the art would understand that the gene shuffling aspect of this method can be modified in ways known in the art. See e.g., U.S. Pat. Nos. 6,951,719 and 6,991,922, which are hereby incorporated by reference in their entirety.

In another preferred embodiment, the invention the modified fragments obtained in each of the preceding described methods can be used in Methods of gene shuffling.

According to this the invention also relates to the use of modified fragments obtained according to any one if the preceding described methods in a method of gene shuffling.

The Methods of gene shuffling are known in the art and described herein. See, e.g., U.S. Pat. Nos. 6,951,719 and 6,991,922, which are hereby incorporated by reference in their entirety. In one embodiment, the gene shuffling technology is L-shuffling. See, e.g., U.S. Pat. No. 6,951,719, incorporated by reference herein in its entirety.

### Polynucleotide Libraries

In another embodiment, the invention includes polynucleotide libraries produced by the processes described herein.

The invention also provides for a recombined polynucleotide library derived from parental polynucleotide(s), wherein the recombined polynucleotide library comprises at least one polynucleotide fragment comprising insertion and/or deletion mutations that preserve the open-reading frame of a polynucleotide of the parental polynucleotide(s).

The following examples illustrate aspects of the invention and are not intended to limit the invention in any way.

### EXAMPLE 1

Preparation of Lipase

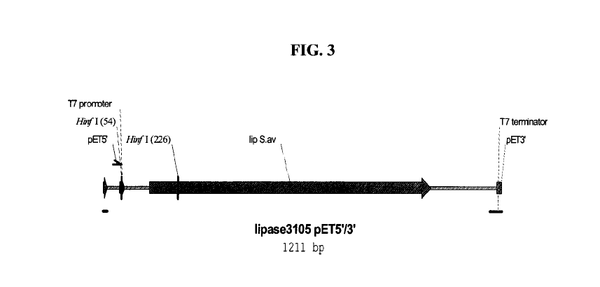

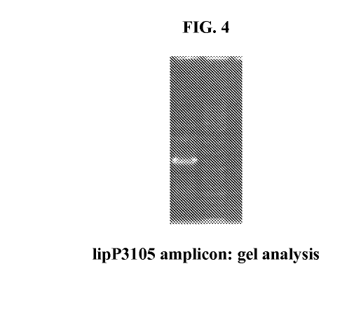

The DNA sequence encoding lipase from P3105 (Streptomyces avermitilis DSM46492) was amplified from the plasmid pET26-lipP3105, using pET5′ and pET3′ primers. A map of this DNA sequence is illustrated in FIG. 3. Ten 100 μl PCR reactions were performed, pooled and concentrated by ethanol precipitation and finally purified using PCT purification kit (QIAQUICK). 2 μl of the purified PCR product were loaded on agarose gel and read under UV after BET coloration, as shown in FIG. 4.

Digestion of the PCR Product with Hinf I

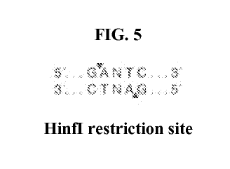

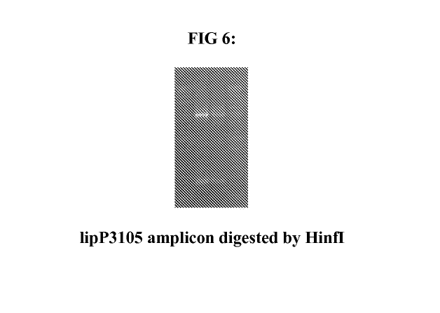

25 μl of the lipase P3105 PCR product were digested with Hinfl restriction enzyme, generating a 5′ end overhanging with a 3 nucleotide single-stranded tail, allowing the insertion or deletion of one amino acid. FIG. 5. The Hinfl digestion generates two fragments of 170 and 980 bp. FIG. 6. After checking the digestion, the digested products were purified prior to digestion or repair treatment of the 5′ overhanging ends.

5′ Overhanging End Repair

The 5′ overhanging ends generated by Hinfl digestion were repaired by treatment with T4 DNA polymerase (6 units) in the presence of 50 mM NaCl, 10 mM Tris-HCl, 10 mM MgCl₂ and 1 mM DTT (pH7.9 at 25° C.) to produce modified polynucleotide fragments. The reaction medium was supplemented with 0.05 mg/ml BSA and 100 μM of each dNTP. The reaction was carried out during 2 hours at 12° C. and then purified using Qiaquick kit.

5′ Overhanging End Digestion

The 5′ overhanging ends generated by Hinfl digestion were digested using Mung Bean Nuclease (10 units) in the presence of 50 mM sodium acetate (pH5.0 at 25° C.), 30 mM NaCl, and 1 mM ZnSO4 to produce modified polynucleotide fragments. The reaction was carried out for 2 hours at 30° C. and then purified using a QIAQUICK kit.

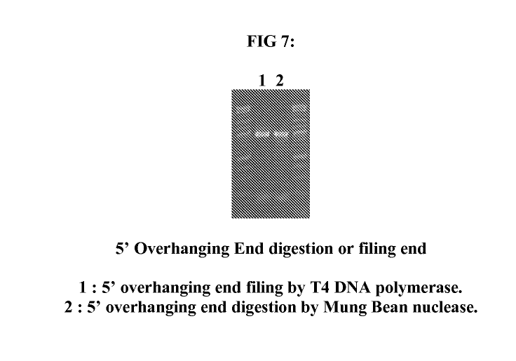

2 μL samples of each of the modified polynucleotides produced by 5′ overhanging end repair and digestion of the 5′ overhanging end were run on an agarose gel. FIG. 7.

Ligation of the Modified Polynucleotide Fragments

Two ligases were used for the construction of library using modified polynucleotide fragments prepared as described above:

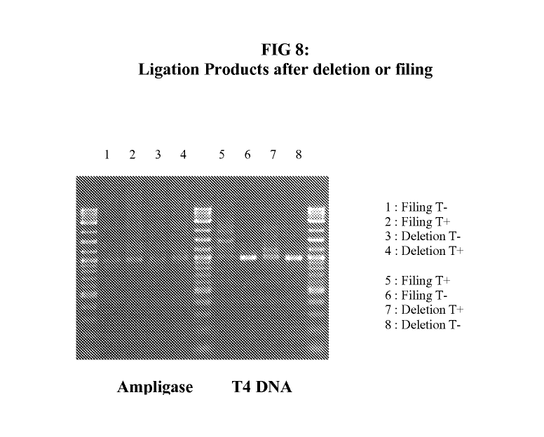

5 μL of modified polynucleotide fragments were incubated with thermostable ligase, (10 units) in 20 mM Tris-HCl (pH 8.3), 25 mM KCI, 10 mM MgCl₂, 0.5 mM NAD, and 0.01% Triton® X-100. After an initial denaturation step, 40 cycles of denaturation/ligation were performed at 94° C. and 65° C. (FIG. 8).

5 μL of modified polynucleotide fragments were incubated with T4 DNA ligase in 50 mM Tris-HCl (pH 7.5 at 25° C.), 10 mM MgCl₂, 10 mM DTT and 1 mM ATP. The ligation reaction was carried out at 4° C. over night. (FIG. 8).

2 μL samples of the ligation products were run on an agarose gel. (FIG. 8)

Hinfl Digestion of Selected Clones

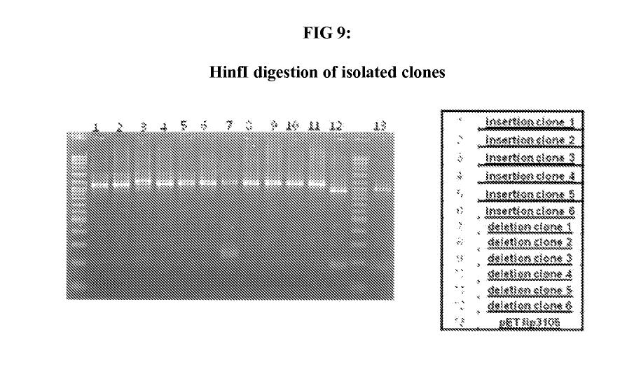

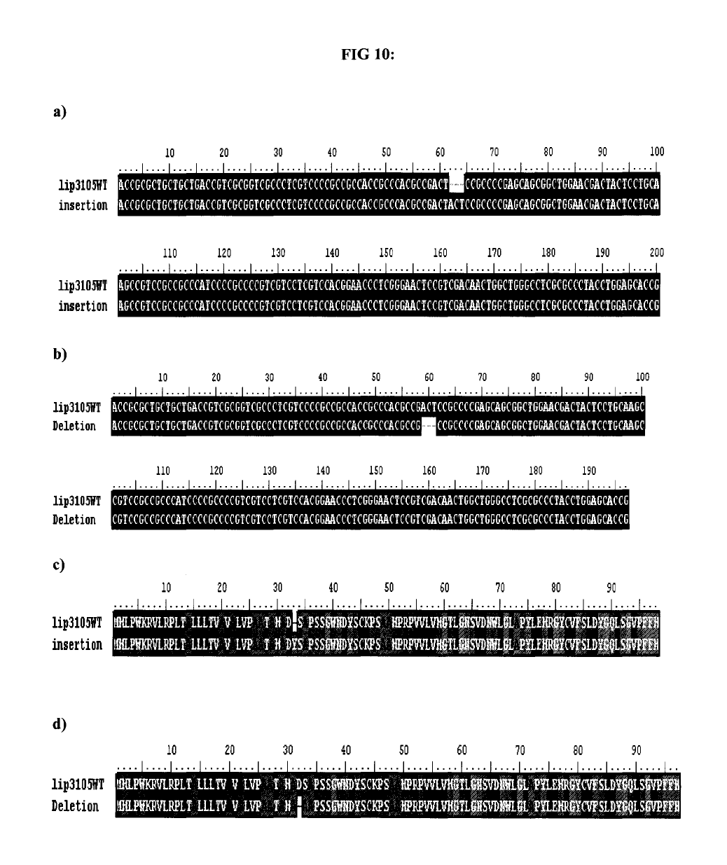

After purification (QIAQUICK 50 μl), the ligation products were digested by appropriate restriction enzymes allowing oriented cloning in pET26. After validation of the insertion percentage of the libraries by PCR on the colonies, the PCR products were digested by Hinfl. (FIG. 9). Some clones that appeared undigested by Hinfl were cultured again in order to confirm, by digestion and sequencing, the loss of Hinfl restriction site, and to test their activity. (FIG. 10).

Only two clones have the same profile as the original gene; all the others were not further digested by Hinfl.

Activity Test

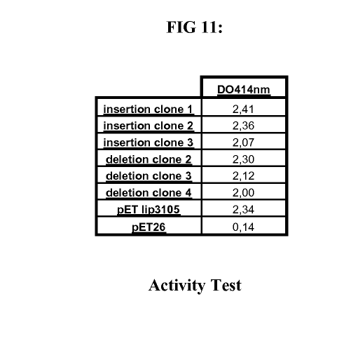

The hydrolytic activity of the lipase clones was measured according to D. Lagarde, et al., Org. Process Res. Dev., Vol. 6, pp. 441, 2002, by monitoring the concentration of p-nitrophenol liberated from 2-hydroxy-4-p-nitrophenoxy-butyl decanoate (C10-HpNPB) at a wavelength of λ=414 nm. All reagents and buffers were prepared in deionized MilliQ® water. A 20 mM stock solution of C10-HpNPB in DMSO was prepared, and BSA solution was prepared as a stock solution (50 mg/ml) in water. NaIO₄ solution was freshly prepared as a 100 mM stock solution in water. 200 μl of non induced culture have been centrifuged and pellets were resuspended with 8 μl of C10-HpNPB stock solution and 84 μl of 200 mM PIPES buffer at pH 7.0. The reaction mixture was incubated at 50° C. for 2 h. The sample was cooled down on ice, and BSA (2 mM), NaIO4, (28 mM) and Na₂CO₃ (40 mM) were added to the mixture. After 10 min of incubation at 25° C., the sample was centrifuged at 6000 g for 5 min and transferred to a microplate. The optical density of the yellow p-nitrophenol was recorded at λ=414 nm using a Sp max 190 microplate spectrophotometer (Molecular Devices). FIG. 11. All the tested clones retain lipase activity in the tested conditions there is no improvement, our first objective was to show that activity can be retained after such sequence modifications.

This example demonstrates the creation of a polynucleotide library comprising a polynucleotide encoding a functional lipase using an embodiment of the invention as disclosed herein.

### EXAMPLE 2

Parental polynucleotides encoding lipase variants is obtained from example 1. Using the method described in Example 1, these polynucleotides are digested with Hinfl restriction enzyme to generate fragments with single-stranded overhanging ends comprising three nucleotide residues each. Some of the resulting fragments are digested with Mung Bean Nuclease to remove the single-stranded overhanging ends, producing modified polynucleotide fragments. The other resulting fragments are treated with T4 DNA polymerase to repair the single-stranded overhanging ends by gap-filling, producing additional modified polynucleotide fragments. The modified polynucleotide fragments are then ligated together using Ampligase, or another suitable ligase, to produce recombined polynucleotides encoding mutant lipase proteins comprising insertion and/or deletion mutations. These recombined polynucleotides are included in a new polynucleotide library. Other polynucleotides encoding variants of the lipase enzyme may also be included in the new library.

Each of the polynucleotides of the new library are used to produce their encoded lipase enzyme. Each of the corresponding lipase enzymes is then screened for lipase activity. Those polynucleotides encoding lipase enzymes that possess the greatest lipase activity are selected for further evaluation and inclusion in additional rounds of directed protein evolution.

Subsequent rounds of directed protein evolution may include the insertion and/or deletion methods described herein. These further rounds may also include any other known method for introducing variation (e.g. other mutagenesis techniques) alone or in combination with the insertion and/or deletion methods described herein. One of skill in the art will appreciate that at the end of each round, polynucleotides encoding lipase enzymes with desirable properties may be selected for further rounds of modification and evaluation as part of a program of in vitro directed protein evolution.

### EXAMPLE 3

The modified polynucleotide fragments obtained following the exonuclease digestion and/or polymerase gap-filling procedures of Examples 1 or 2 may be shuffled together according to methods known in the art. Specifically, the modified polynucleotide fragments are hybridized to an assembly matrix so that the hybridized fragments are properly oriented for ligation with one another. The hybridized modified polynucleotide fragments are then ligated to one another using a suitable ligase to produce a new polynucleotide library. The new polynucleotide library may then be used in subsequent rounds of directed protein evolution, as described herein. After multiple rounds of directed protein evolution according to the methods described herein, an improved variant of the lipase enzyme is obtained having improved properties as compared to a reference version of the lipase enzyme (i.e. a lipase used as a parental enzyme).

### EXAMPLE 4

Preparation of Phytase

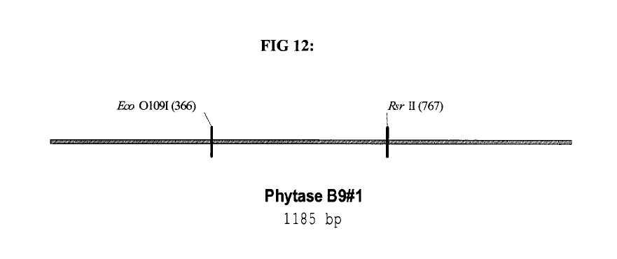

The DNA sequence encoding phytase from B9#1 (Bacillus licheniformis) was amplified from the plasmid pET26Cm-B9#1, using pET5′ and pET3′ primers. A map of this DNA sequence is illustrated in FIG. 12. Ten 100 μl PCR reactions were performed, pooled and concentrated by ethanol precipitation and finally purified using PCR purification kit (QIAQUICK). 2 μl of the purified PCR product were loaded on agarose gel and read under UV after BET coloration.

Digestion of the PCR with Eco0109I or RsrII

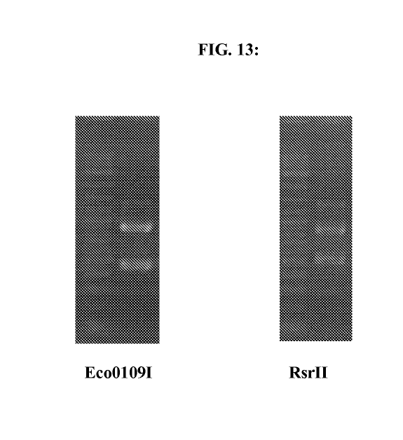

50 μl of the phytase B9#1 PCR product were digested with restriction enzymes Eco0109I or RsrII, generating 5′ end overhanging of 3 bases, allowing the insertion or deletion of one amino acid. The Eco0109I digestion generated two fragments of 366 and 818 basepairs. RsrII digestion lead to two fragments of 767 and 418 basepairs. After checking the digestions, the digested products were purified before repair treatment of the overhanging 5′ end (i.e. gap-filling using DNA polymerase). (FIG. 13).

Overhanging End Repair

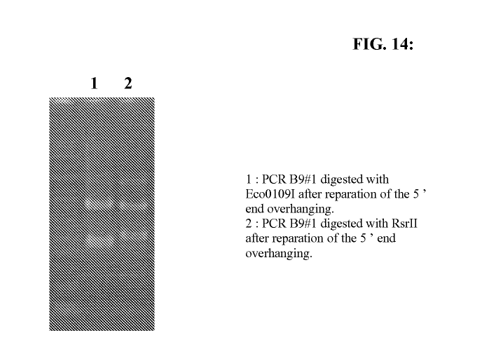

The 5′ overhanging ends generated by Eco01091 and Rsrll digestions were repaired by treatment with T4 DNA polymerase (6 units) in the presence of 50 mM NaCl, 10 mM Tris-HCl, 10 mM MgC1₂ and 1 mM DTT (pH7.9 @25° C.) to produce modified polynucleotide fragments. The reaction medium was supplemented with 0.05 mg/ml of BSA and 100 μM of each dNTP. The reaction was carried out during 2 hours at 12° C. then purifyed using Qiaquick kit. FIG. 14.

Ligations of the Modified Polynucleotide Fragments

The modified polynucleotide fragments were ligated using the thermostable ligase, Ampligase (10 units), with 20 mM Tris-HCl (pH8.3), 25 mM KCl, 10 mM MgC1₂, 0.5 mM NAD, and 0.01% Triton® X-100. After an initial step of denaturation, 40 cycles of denaturation/ligation were performed at 94 and 65° C.

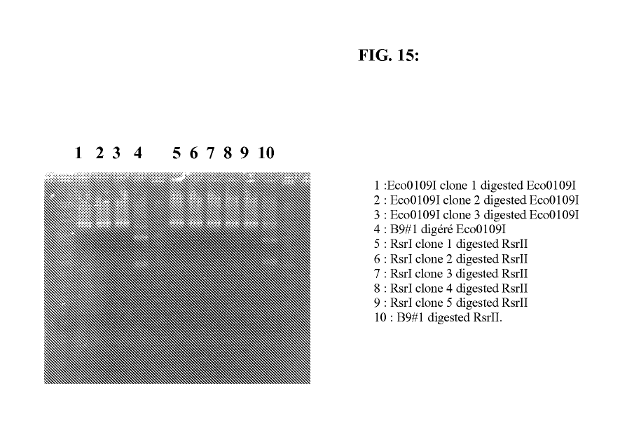

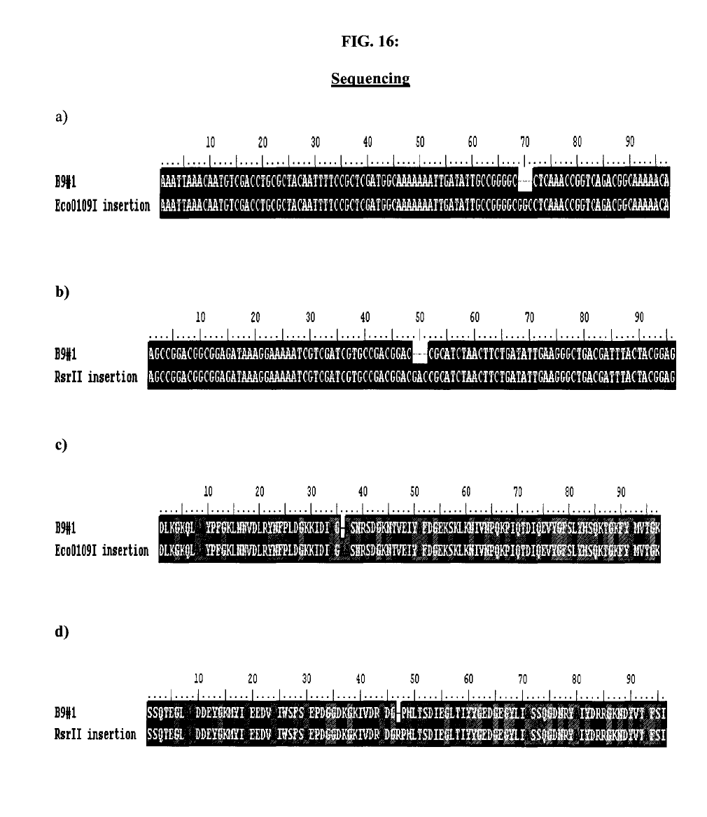

After purification (Qiaquick 50 μl), the ligation products were digested using appropriate enzymes and cloned in pET26Cm. After validation of the percentage of insertion of the libraries by PCR on colonies, the PCR products were digested with Eco0109I or RsrII. Certain clones that did not appear to be further digested by restriction enzymes were cultured again in order to confirm, by digestion and sequencing, the disappearance of the cutting site. FIGS. 15 and 16.

Digestion of the Selected Clones

All the tested clones were not further digested by Eco0109I and RsrII, indicating successful removal of the restriction enzyme recognition site.

Activity Test

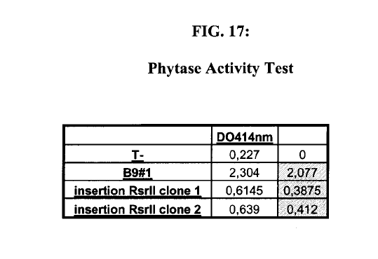

Activity test was performed by monitoring of p-nitrophenol released from p-nitrophenyl-phosphate (pNPP) at a wavelength of 414 nm. Wild type and mutant enzymes were produced in E.coli MC1061 DE3 cells. The cultures were done at 30° C. during 20 hours, with a final concentration of 100 μM IPTG and 10 mM CaC1₂ After cell lysis, enzymes were purified by Ni-NTA affinity chromatography, 10 μl of purified enzymes (3 μg) were added to 90 μl pNPP 10 mM, CaC1₂20 mM and incubated 1 hour at 50° C. To stop the reaction, samples were cooled on ice for 5 minutes and 100 μl of 0.2M Na₂Co₃ were added to the mixture. After 10 min of incubation at 25° C., the sample was centrifuged at 6000 g for 5 min and 150 μl transferred to microplate. The optical density was recorded at λ=414 nm using a Sp max 190 microplate spectrophotometer (Molecular Devices). FIG. 17.

Accordingly, this example demonstrates the creation of a polynucleotide library comprising a polynucleotide encoding a phytase with an insertion mutation using an embodiment of the invention as disclosed herein. This example show that the selected mutant from the library has one amino acid insertion while retaining phytase activity.

### EXAMPLE 5

Parental polynucleotides encoding phytase enzyme variants is obtained from Example 4. Using the method described in Example 1, these polynucleotides are digested with Eco0109I or RsrII, or other appropriate restriction enzymes, to generate fragments with single-stranded overhanging ends comprising three nucleotide residues each. Some of the resulting fragments are digested with an appropriate exonuclease to remove the single-stranded overhanging ends, producing modified polynucleotide fragments. The other resulting fragments are treated with an appropriate polymerase to repair the single-stranded overhanging ends by gap-filling, producing additional modified polynucleotide fragments. The modified polynucleotide fragments are then ligated together using Ampligase, or another suitable ligase, to produce recombined polynucleotides encoding mutant phytase proteins comprising insertion and/or deletion mutations. These recombined polynucleotides are included in a new polynucleotide library. Other polynucleotides encoding variants of the phytase enzyme may also be included in the new library.

Each of the polynucleotides of the new library are used to produce their encoded phytase enzyme. Each of the corresponding phytase enzymes is then screened for phytase activity. Those polynucleotides encoding phytase enzymes that possess the greatest phytase activity are selected for further evaluation and inclusion in additional rounds of directed protein evolution.

Subsequent rounds of directed protein evolution may include the insertion and/or deletion methods described herein. These further rounds may also include any other known method for introducing variation (e.g. other mutagenesis techniques) alone or in combination with the insertion and/or deletion methods described herein. One of skill in the art will appreciate that at the end of each round, polynucleotides encoding phytase enzymes with desirable properties may be selected for further rounds of modification and evaluation as part of a program of in vitro directed protein evolution.

### EXAMPLE 6

The modified polynucleotide fragments obtained following the exonuclease digestion and/or polymerase gap-filling procedures of the Examples 4 and 5 may be shuffled together according to methods known in the art. Specifically, the modified polynucleotide fragments are hybridized to an assembly matrix so that the hybridized fragments are properly oriented for ligation with one another. The hybridized modified polynucleotide fragments are then ligated to one another using a suitable ligase to produce a new polynucleotide library. The new polynucleotide library may then be used in subsequent rounds of directed protein evolution, as described herein. After multiple rounds of directed protein evolution according to the methods described herein, an improved variant of the phytase enzyme is obtained having improved properties as compared to a reference version of the phytase enzyme (i.e., a phytase enzyme represented as a parental enzyme).

All documents (e.g., patents and published patent applications) mentioned herein are hereby incorporated by reference in their entirety.

1) An in vitro method of obtaining a modified polynucleotide fragment library from parental polynucleotides, comprising:
i. providing one or more parental polynucleotides;
ii. applying one or more types of restriction enzymes to said parental polynucleotides to produce polynucleotide fragments, wherein at least one of said polynucleotide fragment comprises at least one overhanging end, said overhanging end comprising a single-stranded portion of said polynucleotide fragment, wherein said single-stranded portion comprises three nucleotide residues or nucleotide residues in multiple of three;
iii. modifying said at least one overhanging end of said polynucleotide fragment to produce a modified polynucleotide fragment, wherein said modifying comprises:
(a) removing all of the nucleotide residues of said overhanging end of one or more polynucleotide fragments;
(b) extending the single strand of the polynucleotide fragment complementary to the strand that comprises the overhanging end to make a double-stranded; or
(c) both (a) and (b),
iv. recovering the resulting modified polynucleotide fragments as a modified polynucleotide fragments library.

2) The method according to claim 1, further comprising:
i. linking at least two of said modified polynucleotide fragments together to obtain at least one modified polynucleotide; and recovering the resulting modified polynucleotide obtained as a modified polynucleotide library.

3) The method according to claim 2, said method further comprising the step of repeating one or more times and wherein at least one of the polynucleotides of the modified polynucleotide library is included as parental polynucleotide.

4) The method of according to claim 1, further comprising:
v. hybridizing said modified polynucleotide fragments to an assembly matrix so that the hybridized fragments are oriented for ligation with each other; and
vi. ligating the hybridized fragments with a ligase to form random recombinant polynucleotide;
vii. recovering the resulting polynucleotide obtained in step (vi) as a polynucleotide library.

5) The method according to claim 4, further comprising the step of repeating steps (v.) to (vi.) one or more times.

6) An in vitro method for directed protein evolution comprising:
i. obtaining modified polynucleotide according to claim 2;
ii. screening some or all of said modified polynucleotides to determine which polynucleotide or polynucleotides encode a protein or proteins of interest;
iii. recovering the modified polynucleotide encoding a protein or proteins of interest obtained in step ii).

7) An in vitro method of preparing polynucleotides fragments for use in polynucleotide shuffling, comprising:
i. obtaining a library of polynucleotide fragments from at least one parental polynucleotide comprising
(a) providing one or more parental polynucleotides encoding a protein with a selected property;
(b) applying one or more types of restriction enzymes to the polynucleotide to produce polynucleotide fragments, wherein at least one polynucleotide fragment comprises at least one overhanging end, said overhanging end comprising a single-stranded portion of the polynucleotide fragment, wherein said singlestranded portion comprises nucleotide residues in multiples of three;
(c) modifying said at least one overhanging end of a polynucleotide fragment to produce a modified polynucleotide fragment, wherein said modifying comprises:
1. removing, in multiples of three, all of the nucleotide residues of said overhanging end of one or more polynucleotide fragments; or
2. extending the strand of the polynucleotide fragment complementary to the strand that comprises the overhanging end to make the single-stranded overhanging end of one or more polynucleotide fragments doublestranded; or
3. both (i) and (ii),
wherein said steps (1)-(3) are carried out in vitro; and
(d) recovering the resulting modified polynucleotide fragments;
ii. constructing a library of mutant polynucleotides comprising the modified polynucleotide fragments using gene shuffling technology.

8) The method according to claim 1, wherein removing all of the nucleotide residues of said overhanging end of one or more polynucleotide fragments is performed with a nuclease.

9) The method according to claim 8, wherein the nuclease is Mung Bean nuclease, Exonuclease I, Exonuclease T, or Lambda Exonuclease.

10) The method according to claim 1, wherein extending the single strand of the polynucleotide fragment complementary to the strand that comprises the overhanging end to make a double-stranded is performed with a DNA polymerase.

11) The method according to claim 8, wherein the DNA polymerase is T4 DNA polymerase, Bsu DNA polymerase, Large Fragment, T7 DNA polymerase, DNA Polymerase I, Large (Klenow) Fragment, or Klenow Fragment (3′→5′ exo-).

12) An in vitro method for directed protein evolution comprising:
i. obtaining modified polynucleotide according to claim 3;
ii. screening some or all of said modified polynucleotides to determine which polynucleotide or polynucleotides encode a protein or proteins of interest;
iii. recovering the modified polynucleotide encoding a protein or proteins of interest obtained in step (ii).

13) An in vitro method for directed protein evolution comprising:
i. obtaining modified polynucleotide according to claim 4;
ii. screening some or all of said modified polynucleotides to determine which polynucleotide or polynucleotides encode a protein or proteins of interest;
iii. recovering the modified polynucleotide encoding a protein or proteins of interest obtained in step (ii).

14) An in vitro method for directed protein evolution comprising:
i. obtaining modified polynucleotide according to claim 5;
ii. screening some or all of said modified polynucleotides to determine which polynucleotide or polynucleotides encode a protein or proteins of interest;
iii. recovering the modified polynucleotide encoding a protein or proteins of interest obtained in step (ii).
